(19) United States
(12) Patent Application Publication
(10) Pub. No.: US 2011/0107395 A1
(43) Pub. Date: May 5, 2011

(54) METHOD AND APPARATUS FOR PROVIDING A FAST AND SECURE BOOT PROCESS

(75) Inventors: Janne Petteri Takala, Tampere (FI); Rauno Juhani Tamminen, Tampere (FI)

(73) Assignee: Nokia Corporation

(21) Appl. No.: 12/611,403

(22) Filed: Nov. 3, 2009

(51) Int. Cl. G06F 7/04; G06F 15/177

(52) U.S. Cl. 726/2; 713/2

(57) ABSTRACT

An apparatus for providing a fast and secure boot process may include at least one processor and at least one memory including computer program code. The at least one memory and the computer program code may be configured to, with the at least one processor, cause the apparatus to perform at least performing a first security check on critical security software during a boot sequence of a device, powering down or resetting the device in response to failure of the first security check, performing a second security check on at least a first portion of general critical software in response to the first security check passing, enabling operation of the device with respect to general critical software that passes the second security check, and disabling functionality associated with general critical software that fails the second security check.

### TECHNOLOGICAL FIELD

Embodiments of the present invention relate generally to electronic device technology and, more particularly, relate to a method and apparatus for providing a fast and secure boot process that may be used, for example, on open source or public license software.

### BACKGROUND

In order to provide easier or faster information transfer and convenience, telecommunication industry service providers are continually developing improvements to existing communication networks. Concurrent with the improvements made to networks, the electronic communication devices that are used in connection with these networks are also continually improving. The improvement of networks and the communication devices that utilize these networks has resulted in wide availability and wide usage of a vast array of services and applications.

The services and applications that are developed, and continue to be developed are typically supported by a combination of hardware platforms and corresponding software. For example, a new mobile telephone may include improved hardware supporting battery saving technology, new display technology, increased processing speed and other improvements. Meanwhile, the enhanced capabilities provided by the improved hardware may enable the new mobile phone to run corresponding new software. Given the expanding capabilities of electronic devices, many types of software applications are being developed to make such devices more useful for communication, task accomplishment, entertainment, social interaction and other purposes.

The electronic devices developed may sometimes be configured to enable operation only with specific software (e.g., proprietary software). However, some devices may be considered open source or public license devices that enable third parties to develop and run their own operating system (OS) level or middleware software on the devices. Meanwhile, the electronic devices may sometimes also have certain functionalities that require a secure boot process. For example, functionalities like digital rights management (DRM) typically require validation of a security critical code (e.g., using a public-key cryptography based digital signing). Such validation may be employed to establish trust for critical software. Critical software, as used herein, may refer to software for which a basis of trust must be established due to contractual obligations or liability related concerns. Accordingly, critical software may be considered “critical” from a security perspective and may include many types of software (e.g., software that involves portions of the operating system for the corresponding device (e.g., kernel), middleware (e.g., audio subsystem), and some applications (e.g., music player). Given the potentially large amount of critical software (as evidenced by the examples listed above), a relatively large amount of software may need to be validated in the manner described above, or some similar fashion, during a secure boot process. Performance of an integrity or security check over a large footprint of critical software may take a substantial amount of time (e.g., on the order of seconds) and result in slow boot up times and reduced user enjoyment. Moreover, since some public licenses may require that the user be enabled to develop and run software tailored to the user's purposes (including modifications to critical software), a conflict may be created between DRM contractual requirements and open source or public license requirements.

Accordingly, it may be desirable to provide a mechanism by which at least some of the issues discussed above may be addressed.

### BRIEF SUMMARY

A method, apparatus and computer program product are therefore provided for enabling the provision of a fast and secure boot process for use with open source or public license software. Moreover, some embodiments of the present invention may provide a mechanism by which the user may be enabled or disabled from running altered software on a product variant by product variant basis. Accordingly, several deficiencies discussed above may be addressed.

In one example embodiment, a method of providing a fast and secure boot process is provided. The method may include performing a first security check on critical security software during a boot sequence of a device, powering down or resetting the device in response to failure of the first security check, performing a second security check on at least a first portion of general critical software in response to the first security check passing, enabling operation of the device with respect to general critical software that passes the second security check, and disabling functionality associated with general critical software that fails the second security check.

In another example embodiment, a computer program product for providing a fast and secure boot process is provided. The computer program product includes at least one computer-readable storage medium having computer-executable program code instructions stored therein. The computer-executable program code instructions may include program code instructions for performing a first security check on critical security software during a boot sequence of a device, powering down or resetting the device in response to failure of the first security check, performing a second security check on at least a first portion of general critical software in response to the first security check passing, enabling operation of the device with respect to general critical software that passes the second security check, and disabling functionality associated with general critical software that fails the second security check.

In another example embodiment, an apparatus for providing a fast and secure boot process is provided. The apparatus may include at least one processor and at least one memory including computer program code. The at least one memory and the computer program code may be configured to, with the at least one processor, cause the apparatus to perform at least performing a first security check on critical security software during a boot sequence of a device, powering down or resetting the device in response to failure of the first security check, performing a second security check on at least a first portion of general critical software in response to the first security check passing, enabling operation of the device with respect to general critical software that passes the second security check, and disabling functionality associated with general critical software that fails the second security check.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a system according to an exemplary embodiment of the present invention;

FIG. 3 is a schematic block diagram of an apparatus for providing a fast and secure boot process according to an exemplary embodiment of the present invention;

FIG. 4 is a block diagram illustrating a process flow for providing a fast and secure boot process according to an exemplary embodiment of the present invention; and

FIG. 5 is a block diagram according to an example method for providing a fast and secure boot process according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a physical storage medium (e.g., volatile or non-volatile memory device), can be differentiated from a “computer-readable transmission medium,” which refers to an electromagnetic signal.

Electronic devices have been rapidly developing in relation to their communication and processing capabilities. The existence of open source and public license software, for which license requirements typically require that the source code be made available for modification by users, can be useful for enhancing the capabilities of such devices. However, functionalities having certain requirements for security that require a secure boot up procedure may not be easily compatible with devices operating open source or public license software. Moreover, as indicated above, the secure boot procedure could be long for large critical software footprints.

One mechanism for dealing with the issue of compatibility that has been developed is referred to as “Tivoization”. This mechanism involves the incorporation of open source or public license software, but uses hardware to prevent users from running modified versions of the software on that particular hardware. As such, for example, the device will comply with open source requirements in relation to release of its source code for modification. However, if the device recognizes open source based software that has been modified, the device will not allow the modified software to be operated on the device. Thus, in some cases, the device may deny certain services or the device may power down or reset if a security check fails (e.g., due to a digital signature of the software failing to match a stored digital signature on the device during a signature check).

Some embodiments of the present invention may provide a change to the boot procedure to increase the speed of the boot process. Some embodiments may also or alternatively provide for a method of allowing or disallowing modified software on a product variant by product variant basis.

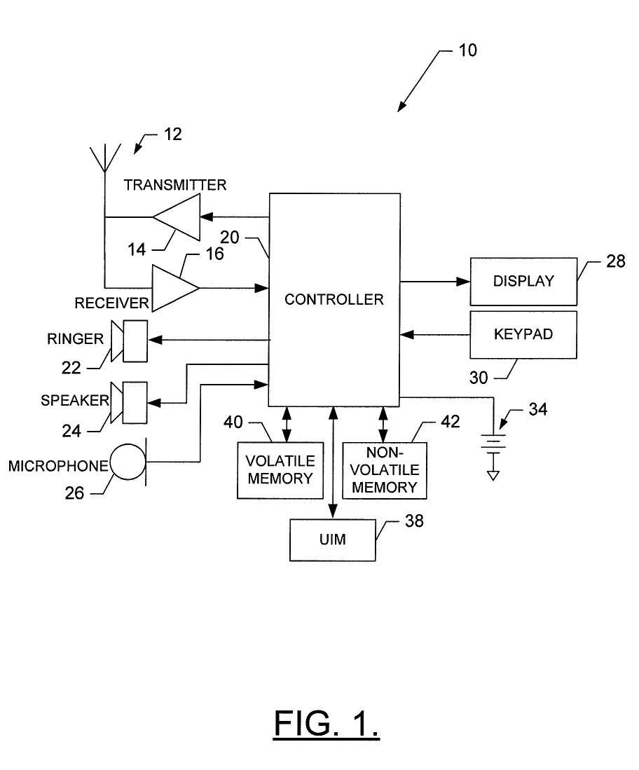

FIG. 1, one example of a host device for implementation of an exemplary embodiment of the invention, illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, gaming devices, all types of computers (e.g., laptops or mobile computers), cameras, audio/video players, radio, global positioning system (GPS) devices, or any combination of the aforementioned, and other types of communications systems, may readily employ embodiments of the present invention.

The mobile terminal 10 may include an antenna 12 (or multiple antennas) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN (evolved-universal terrestrial radio access network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

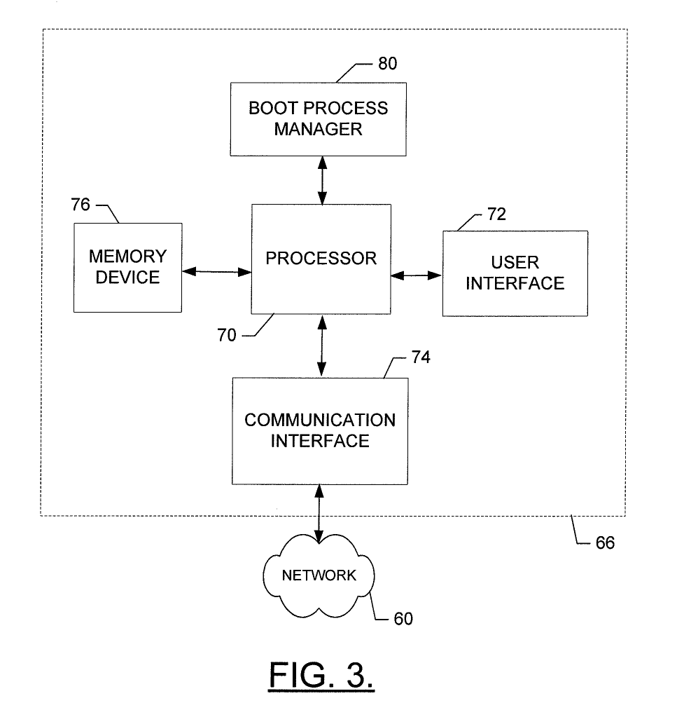

It is understood that the controller 20 may include circuitry implementing, among others, audio and logic functions of the mobile terminal 10. For example, the controller 20 may comprise a digital signal processor device, a microprocessor device (e.g., processor 70 of FIG. 3), and various analog to digital converters, digital to analog converters, and/or other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown), a microphone or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 may additionally or alternatively comprise an electrically erasable programmable read only memory (EEPROM), flash memory or the like. The memories may store any of a number of pieces of information, and data, used by the mobile terminal 10 to implement the functions of the mobile terminal 10. For example, the memories may include an identifier, such as an international mobile equipment identification (IMEI) code, capable of uniquely identifying the mobile terminal 10.

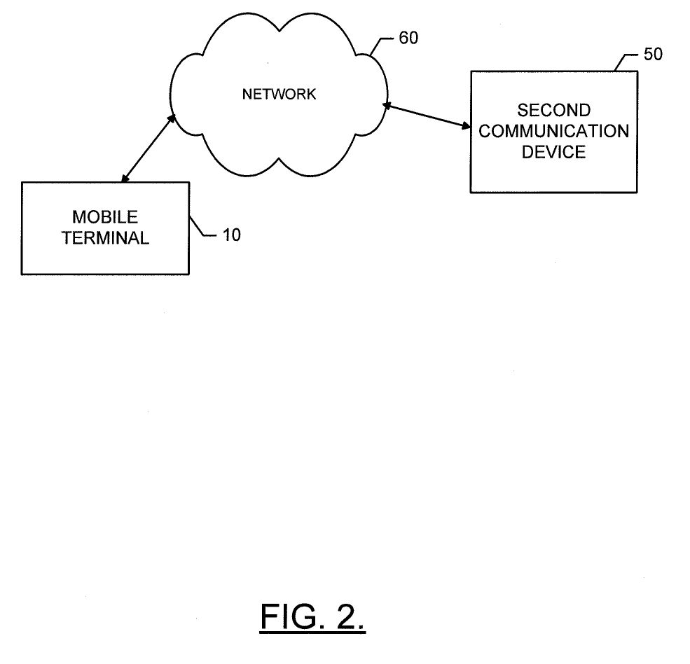

FIG. 2 illustrates a generic system diagram in which a device such as a mobile terminal 10, which may benefit from embodiments of the present invention, is shown in an exemplary communication environment. In this regard, the mobile terminal 10 may be configured to include an apparatus for providing a fast and secure boot process in accordance with an exemplary embodiment. As shown in FIG. 2, an embodiment of a system in accordance with an example embodiment of the present invention may include a first communication device (e.g., mobile terminal 10) and a second communication device 50 capable of communication with each other. In an exemplary embodiment, the mobile terminal 10 and the second communication device 50 may be in communication with each other via a network 60. In some cases, embodiments of the present invention may further include one or more network devices with which the mobile terminal 10 and/or the second communication device 50 may communicate to provide, request and/or receive information. The network devices may include, for example, one or more servers, base stations, access points, gateways, communication controllers or other computers configured to perform various functions. In some cases, embodiments of the present invention may also or alternatively be practiced on one or more of the network devices and/or the communication devices that communicate with each other and/or the network devices.

It should be noted that although FIG. 2 shows a communication environment that may support, in some embodiments, communication between the mobile terminal 10 and the second communication device 50 via the network, other embodiments may also be practiced in the context of communications provided via a direct communication link between the mobile terminal 10 and the second communication device 50. Moreover, embodiments of the present invention may also be practiced without any second communication device and/or without any communication with an external device. In other words, embodiments of the present invention may also be practiced in situations in which the mobile terminal 10 is communicating directly with one or more network devices (e.g., for downloading content or executing functionality associated with an application executed in a client/server environment between the mobile terminal 10 and a device or devices of the network 60) or operating independent of the network 60.

The network 60, if employed, may include a collection of various different nodes, devices or functions that may be in communication with each other via corresponding wired and/or wireless interfaces. As such, the illustration of FIG. 2 should be understood to be an example of a broad view of certain elements of the system and not an all inclusive or detailed view of the system or the network 60. One or more communication terminals such as the mobile terminal 10 and the second communication device 50 may be in communication with each other via the network 60 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and/or the second communication device 50 via the network 60. By directly or indirectly connecting the mobile terminal 10 and/or the second communication device 50 and other devices to the network 60 or to each other, the mobile terminal 10 and/or the second communication device 50 may be enabled to communicate with the other devices or each other, for example, according to numerous communication protocols including Hypertext Transfer Protocol (HTTP) and/or the like, to thereby carry out various communication or other functions of the mobile terminal 10 and/or the second communication device 50, respectively.

Furthermore, although not specifically shown in FIG. 2, the mobile terminal 10 may communicate with other devices in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 50 may be enabled to communicate with the network 60 and each other by any of numerous different access mechanisms. For example, mobile access mechanisms such as wideband code division multiple access (W-CDMA), CDMA2000, global system for mobile communications (GSM), LTE, general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

An exemplary embodiment of the invention will now be described with reference to FIG. 3, in which certain elements of an apparatus for enabling the provision of a fast and secure boot process are displayed. The apparatus of FIG. 3 may be employed, for example, on the mobile terminal 10 of FIG. 1. However, it should be noted that the apparatus of FIG. 3, may also be employed on a variety of other devices, both mobile and fixed (e.g., computers or servers), and therefore, embodiments of the present invention should not be limited to application on devices such as the mobile terminal 10 of FIG. 1. Alternatively, embodiments may be employed on a combination of devices including, for example, those listed above. Accordingly, embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

Referring now to FIG. 3, an apparatus 66 for enabling the provision of a fast and secure boot process is provided. The apparatus 66 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., the mobile terminal 10 or a network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a boot process manager 80. The boot process manager 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the boot process manager 80 as described herein. Thus, in examples in which software is employed, a device or circuitry (e.g., the processor 70 in one example) executing the software forms the structure associated with such means.

The boot process manager 80 of some embodiments is configured to alter the typical boot sequence to improve the speed of the boot sequence while still providing security. Moreover, in some embodiments, the boot process manager 80 is also enabled to provide improved flexibility with respect to performing security checks during the boot sequence. In this regard, for example, the boot process manager 80 may be configured to disable specific critical software that does not pass security checks (e.g., signature checks), while enabling other passing critical software to be operated normally. Furthermore, in some embodiments, the boot process manager 80 is configured to perform the above described enablement on a product variant by product variant basis.

The traditional boot sequence may include an initial power up followed by the performance of a security check on all critical software (e.g., by performing a digital signature check). Based on the security check, the device will either start normal operation (e.g., in response to the signature of the corresponding software being checked matching) or power down or reset (e.g., in response to the signature of a software item being checked failing to match). Meanwhile, the boot process manager 80 may be configured to manage various operations of the boot sequence in order to improve speed and flexibility of security checks on critical software as described in greater detail below.

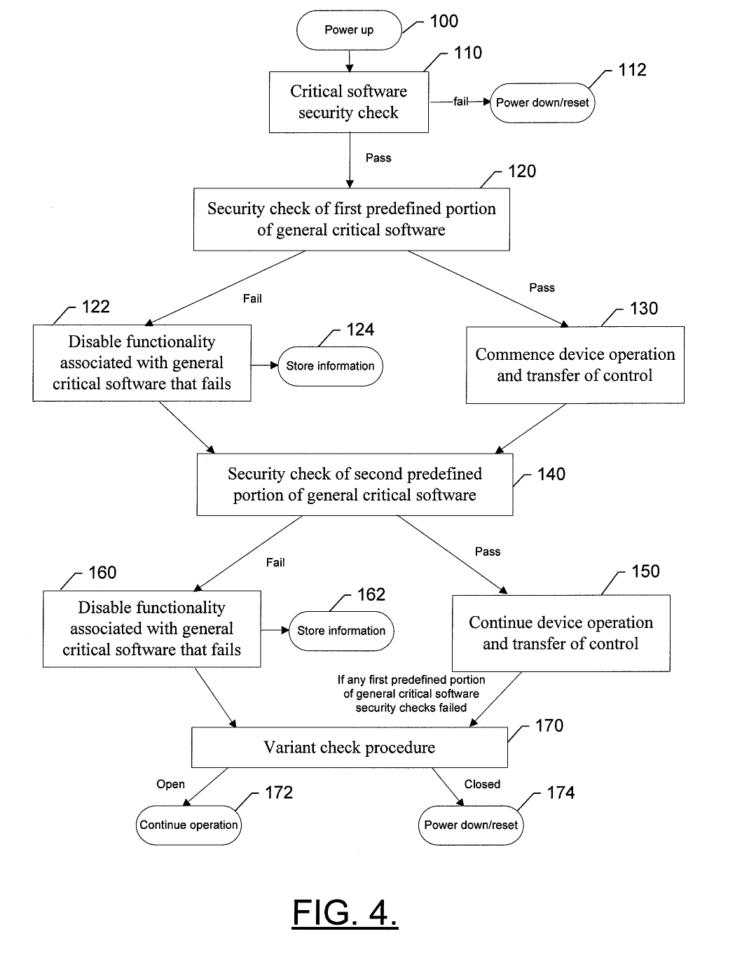

In an exemplary embodiment, the boot process manager 80 initiates a process similar to the process flow shown in FIG. 4 responsive to a power up of a device including critical software. The process of FIG. 4 is different from the traditional boot process by virtue of the segmentation of all of the critical software into specific segments that may be processed more efficiently and, in some cases, may be processed according to different criteria. Accordingly, the boot sequence may not result in a go-no go check as provided in the traditional boot sequence. Instead, a more flexible approach may be provided. The segmentation of the critical software may be accomplished by the boot process manager 80 or at least responsive to control and/or input of the boot process manager 80. In an exemplary embodiment, the critical software is segmented into three groups including a critical security software portion and two separate portions of general critical software.

Criticality as used herein may be defined based on contracts and/or potential liabilities that may exist between stakeholders (e.g., software developers and device manufacturers). As such, for example, if certain liabilities or legal responsibilities may be contractually created by the use of certain software, such software may be considered critical. A device (e.g., the mobile terminal 10) may therefore be directed to verify that critical software can be trusted during the secure boot process. Accordingly, critical security software may be defined as software that is critical to the prevention of the exposure of confidential material. Thus, for example, critical software for which operation despite detection of a change in the software (e.g., by the signature failing to match) could result in the release of or enablement for reading of confidential data would be considered extremely critical or critical security software. Meanwhile, other critical software for which operation despite detection of a change in the software could not result in the release of or enablement for reading of confidential data may be considered general critical software. The division of general critical software into at least two portions (e.g. a first predefined portion and a second predefined portion of the general critical software) could be accomplished based on predefined characteristics determined during development of the boot process manager 80. In other words, the boot process manager 80 may be configured to divide general critical software into at least two groups based on predefined characteristics associated with the respective general critical software packages.

Referring now to FIG. 4, in one example, at operation 100, the power may be turned on. A security check (e.g., a signature check) may then be performed with respect to critical security software at operation 110. In response to the security check failing, a power down or reset may be initiated at operation 112. However, in response to the security check passing, operation may continue to the performance of another security check (e.g., a signature check) on a first predefined portion of the general critical software at operation 120. In response to the security check failing, the corresponding general critical software functionality (e.g., DRM keys) for which the security check failed may be disabled at operation 122 and the information regarding the disabling of such functionality may be stored at operation 124. In response to the security check passing, operation may continue to the commencement of normal operation by transferring control to the first predefined portion of the general critical software at operation 130. Either in parallel with operation of the device (e.g., responsive to completion of operation 120 or operation 130) or in the background, operation 140 may be executed by performing a security check of a second predefined portion of the general critical software. In response to the security check passing, the security check procedure may be complete and normal operation may commence at operation 150. However, in response to the security check not passing (e.g., due to a signature not matching), the corresponding general critical software functionality may be disabled at operation 160. In some cases, information regarding the disabling of such functionality may be stored at operation 162.

Some embodiments may further include a variant check procedure instituted at operation 170 in response to any one of the first or second predefined portions of the general critical software failing the security check. The variant of a particular device may depend on both the hardware and software configuration of the device. Accordingly, for example, in some situations the variant of the device (e.g., the mobile terminal 10) may be recorded along with variant specific configuration data. The variant specific configuration data (which may be provided via a common configuration certificate (CCC) or SIM lock data in some examples) may include an indication as to whether the variant is open or closed in relation to permitting certain software changes. In this regard, in response to the variant being determined to be open, continued operation may be enabled at operation 172, even though one or more pieces of critical software other than critical security software have been disabled. However, in response to the variant being indicated as being closed, continued operation may not be enabled at operation 174, in response to one or more critical software items being disabled. In this regard, for example, the device may be powered down or reset.

As a result of the implementation of the process shown in FIG. 4, the security checks done at operations 110, 120 and 140 may enable the user to have access to operation of the device faster than is possible responsive to the global check done in the traditional boot sequence. Furthermore, the completion of operations 110 and 120 can typically be accomplished quicker than the completion of the global check done in the traditional boot sequence. In this regard, for example, the security checks that take place at operation 120 can typically be executed immediately, while the security checks that take place at operation 140 may involve more time consuming pre-processing. In some cases, some of the security checks at operation 140 may require certain security checks from operation 120 to be complete. However, that is not always the case. In any case, although operation 140 may be performed after operations 110 and 120, the faster completion of operations 110 and 120 relative to the traditional boot sequence may enable a user to begin using the device faster and therefore improve the user's experience. In this regard, for example, after operation 130, operation of the device may begin while operations 140 and beyond may be performed to ensure no security holes are present. Some embodiments of the present invention also provide the variant check procedure that enables a variant by variant determination as to whether operation is permissible with some functionality disabled. In the traditional boot sequence, there is no such option as any security check failure results in power down or reset every time. In some examples, a baseband 5 (BB5) security subsystem, or some other security subsystem, may implement the critical security software check and/or the general critical software security checks.

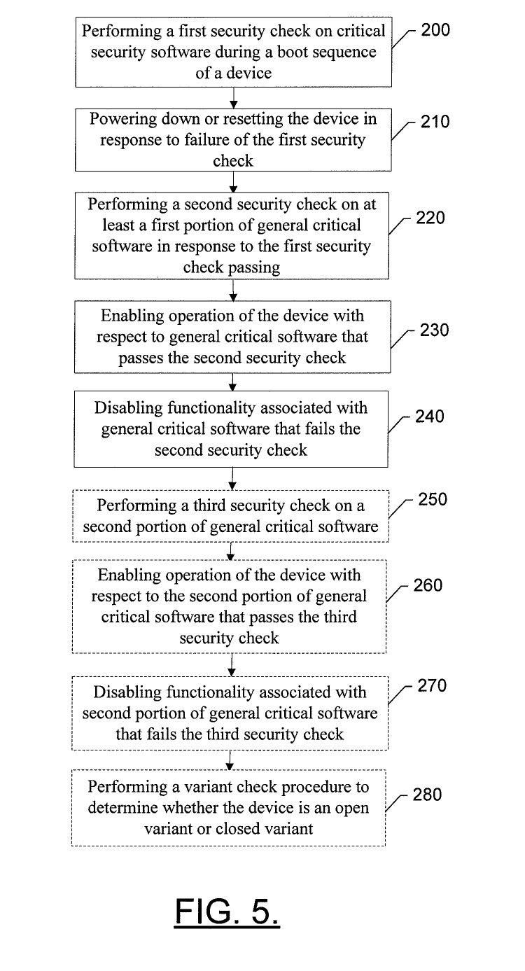

FIG. 5 is a flowchart of a method and program product according to example embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 5, may include performing a first security check on critical security software during a boot sequence of a device at operation 200. The device may be a device including critical software as defined herein. The method may further include powering down or resetting the device in response to failure of the first security check at operation 210 and performing a second security check on at least a first portion of general critical software in response to the first security check passing at operation 220. The method may further include enabling operation of the device with respect to general critical software that passes the second security check at operation 230 and disabling functionality associated with general critical software that fails the second security check at operation 240.

In some embodiments, certain ones of the operations above may be modified or further amplified as described below, for example, with additional operations that are indicated in dashed lines in FIG. 5. It should be appreciated that each of the modifications or amplifications below may be included with the operations above either alone or in combination with any others among the features described herein. In this regard, for example, the method may further include performing a third security check on a second portion of general critical software in parallel with operation of the device responsive to completion of the second security check or as a background operation at operation 250. In such examples, the method may further include enabling operation of the device with respect to the second portion of general critical software that passes the third security check at operation 260 and disabling functionality associated with second portion of general critical software that fails the third security check at operation 270. In some embodiments, the method includes performing a variant check procedure to determine whether the device is an open variant or closed variant at operation 280. The variant check procedure may include enabling operation of the device with respect to portions of the general critical software that pass the second security check in response to the device being an open variant or powering down or resetting the device in response to at least one portion of the general critical software not passing the second security check and the device being a closed variant.

In an example embodiment, an apparatus for performing the method of FIG. 4 above may comprise a processor (e.g., the processor 70) configured to perform some or each of the operations (200-280) described above. The processor may, for example, be configured to perform the operations (200-280) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-280 may comprise, for example, the processor 70, the boot process manager 80, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the at least one processor, cause the apparatus at least to perform:
performing a first security check on critical security software during a boot sequence of a device;
powering down or resetting the device in response to failure of the first security check;
performing a second security check on at least a first portion of general critical software in response to the first security check passing;
enabling operation of the device with respect to general critical software that passes the second security check; and
disabling functionality associated with general critical software that fails the second security check.

2. The apparatus of claim 1, wherein the at least one memory and the computer program code are further configured to, with the at least one processor, cause the apparatus to perform a third security check on a second portion of general critical software in parallel with operation of the device responsive to completion of the second security check.

3. The apparatus of claim 2, wherein the at least one memory and the computer program code are further configured to, with the at least one processor, cause the apparatus to:
enable operation of the device with respect to the second portion of general critical software that passes the third security check; and
disable functionality associated with second portion of general critical software that fails the third security check.

4. The apparatus of claim 1, wherein the at least one memory and the computer program code are further configured to, with the at least one processor, cause the apparatus to perform a third security check on a second portion of general critical software as a background operation.

5. The apparatus of claim 4, wherein the at least one memory and the computer program code are further configured to, with the at least one processor, cause the apparatus to:
enable operation of the device with respect to the second portion of general critical software that passes the third security check; and
disable functionality associated with second portion of general critical software that fails the third security check.

6. The apparatus of claim 1, wherein the at least one memory and the computer program code are further configured to, with the at least one processor, cause the apparatus to perform a variant check procedure to determine whether the device is an open variant or closed variant.

7. The apparatus of claim 1, wherein the at least one memory and the computer program code are further configured to, with the at least one processor, cause the apparatus to:
enable operation of the device with respect portions of the general critical software that pass the second security check in response to the device being an open variant; or
power down or reset the device in response to at least one portion of the general critical software not passing the second security check and the device being a closed variant.

8. The apparatus of claim 1, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

9. The apparatus of claim 1, wherein the at least one memory and the computer program code are further configured to, with the at least one processor, cause the apparatus to, in response to a determination that at least one portion of the general critical software does not pass the second security check and a determination that the device is an open variant, enable operation of the device with respect portions of the general critical software that pass the second security check and disable functionality associated with portions of general critical software that fail the second security check.

10. A method comprising:
performing a first security check on critical security software during a boot sequence of a device;
powering down or resetting the device in response to failure of the first security check;
performing a second security check on at least a first portion of general critical software in response to the first security check passing;
enabling operation of the device with respect to general critical software that passes the second security check; and
disabling functionality associated with general critical software that fails the second security check.

11. The method of claim 10, further comprising performing a third security check on a second portion of general critical software in parallel with operation of the device responsive to completion of the second security check or as a background operation.

12. The method of claim 11, further comprising:
enabling operation of the device with respect to the second portion of general critical software that passes the third security check; and
disabling functionality associated with second portion of general critical software that fails the third security check.

13. The method of claim 10, further comprising, in response to a determination that at least one portion of the general critical software does not pass the second security check and a determination that the device is an open variant, enabling operation of the device with respect portions of the general critical software that pass the second security check and disabling functionality associated with portions of general critical software that fail the second security check.

14. The method of claim 10, further comprising performing a variant check procedure to determine whether the device is an open variant or closed variant.

15. The method of claim 14, further comprising:
enabling operation of the device with respect portions of the general critical software that pass the second security check in response to the device being an open variant; or
powering down or resetting the device in response to at least one portion of the general critical software not passing the second security check and the device being a closed variant.

16. A computer program product comprising at least one computer-readable storage medium having computer-executable program code instructions stored therein, the computer-executable program code instructions comprising:
program code instructions for performing a first security check on critical security software during a boot sequence of a device;
program code instructions for powering down or resetting the device in response to failure of the first security check;
program code instructions for performing a second security check on at least a first portion of general critical software in response to the first security check passing;
program code instructions for enabling operation of the device with respect to general critical software that passes the second security check; and
program code instructions for disabling functionality associated with general critical software that fails the second security check.

17. The computer program product of claim 16, further comprising program code instructions for performing a third security check on a second portion of general critical software in parallel with operation of the device responsive to completion of the second security check or as a background operation.

18. The computer program product of claim 17, further comprising program code instructions for:
enabling operation of the device with respect to the second portion of general critical software that passes the third security check; and
disabling functionality associated with second portion of general critical software that fails the third security check.

19. The computer program product of claim 16, further comprising program code instructions for performing a variant check procedure to determine whether the device is an open variant or closed variant.

20. The computer program product of claim 19, further comprising program code instructions for:
enabling operation of the device with respect portions of the general critical software that pass the second security check in response to the device being an open variant; or
powering down or resetting the device in response to at least one portion of the general critical software not passing the second security check and the device being a closed variant.
